(19) United States
(12) Patent Application Publication
(10) Pub. No.: US 2008/0101467 A1
(43) Pub. Date: May 1, 2008

(54) Method and system for secure and efficient wireless transmission of HDCP-encrypted HDMI/DVI signals

(75) Inventors: Samuel J. MacMullan, Carlisle, MA (US); Tandhoni S. Rao, Ashland, MA (US); Jeff Winston, Sudbury, MA (US); Jianhan Liu, Acton, MA (US); Ming Zhang, Southborough, MA (US)

Correspondence Address: FIALA & WEAVER, P.L.L.C.;C/O INTELLEVATE, P.O. BOX 52050, MINNEAPOLIS, MN, 55402, US

(73) Assignee: Radiospire Networks, Inc., Concord, MA (US)

(21) Appl. No.: 11/588,263

(22) Filed: Oct. 27, 2006

(51) Int. Cl. H04N 7/12

(52) U.S. Cl. 375/240.12; 375/240.26

(57) ABSTRACT

The present invention is directed to methods and systems for enabling secure and efficient wireless transmission of HDCP-encrypted high definition (HD) signals. In one aspect, the present invention provides methods and systems for reducing the data rate required to convey HD content to enable direct wireless transmission of HD content. In another aspect, the present invention provides methods and systems for reducing the data rate required to convey HD content that are compatible with HDCP encryption of content. In a further aspect, the present invention provides methods and systems for reducing the data rate required to convey HD content while maintaining a high quality of content.

### BACKGROUND OF THE INVENTION

1. Field of the Invention

The present invention is generally related to the wireless transmission of high definition (HD) signals.

2. Background

High Definition (HD) signals are typically transmitted from one system to another using cables carrying DVI (Digital Video Interface) or HDMI (High Definition Multimedia Interface) signals.

Conventionally, DVI/HDMI signals are conveyed using a signaling scheme known as Transition Minimized Differential Signaling (TMDS). In TMDS, video, audio, and control data are carried as a series of 24-bit words on three TMDS data channels with a separate TMDS channel for carrying clock information. Additionally, DVI/HDMI systems include a separate bi-directional channel (typically I²C-based) known as the Display Data Channel (DDC) for exchanging configuration and status between a source and a sink, including information needed in support of High-Bandwidth Digital Content Protection (HDCP) encryption and decryption. In HDMI, an optional Consumer Electronic Control (CEC) protocol provides high-level control functions between audiovisual products. FIG. 1 illustrates a conventional HDMI content delivery system 100 that uses a copper HDMI cable 102 to connect an HDMI source 104 and an HDMI display 106. Note that a conventional DVI system would be similar to system 100 with the exception that audio is not carried across a DVI cable.

To condition signals for reliable transmission over copper cables, TMDS adds approximately 25% overhead to video samples and more than 25% to other samples, resulting in multi-Gbps communications data rates for video modes such as 720p, 1080i, and 1080p, for example. In the case of non-video samples, overhead is due to TMDS Error Reduction Coding (TERC4) and Control Period coding.

It is desirable to replace costly and bulky DVI/HDMI copper cables with practical wireless solutions. However, wireless transmissions are often subject to high error rates and forward error correction (FEC) overhead is therefore needed to provide the bit error rate required for adequate content quality. Additionally, several limitations including transmit power, available wireless bandwidth, large separations between source and display, and hardware limitations (baseband processing, radio frequency (RF) and data conversion) preclude the direct wireless transmission of TMDS-encoded HD content that is protected using an amount of FEC overhead adequate to provide acceptable content quality.

Accordingly, it is necessary to reduce, relative to a TMDS-encoded, adequately FEC-protected, transmission, the required wireless data rate without significantly degrading video and/or audio quality. At the same time, it is important to maintain support for HDCP encryption of transmitted content. This is the case due to the significance of HDCP as a protocol approved by MPAA (Motion Picture Association of America) and FCC (Federal Communications Commission) for securely transferring uncompressed DVI/HDMI content, and the fact that certain sources and displays may not support non-HDCP encrypted HD content or may default to non-HD resolutions (e.g., 480i) in the absence of HDCP encryption.

What are needed therefore are methods and systems that enable a reduction of the data rate required to wirelessly convey HD content while being compatible with HDCP encryption and maintaining high quality of content.

### BRIEF SUMMARY OF THE INVENTION

The present invention is directed to methods and systems for enabling secure and efficient wireless transmission of HDCP-encrypted high definition (HD) signals.

In one aspect, the present invention provides methods and systems for reducing the data rate required to convey HD content to enable direct wireless transmission of HD content.

In another aspect, the present invention provides methods and systems for reducing the data rate required to convey HD content that are compatible with HDCP encryption of content.

In a further aspect, the present invention provides methods and systems for reducing the data rate required to convey HD content while maintaining a high quality of content.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 illustrates a conventional HDMI content delivery system.

FIG. 2 illustrates a wireless HDMI content delivery system with HDCP encryption.

FIG. 3 illustrates circuitry for implementing HDCP encryption.

FIG. 4 illustrates a method for calculating not-transmitted video pixel data from transmitted video pixel components in adjacent video frames.

FIG. 5 illustrates a method for data interleaving.

FIG. 6 is a block diagram that illustrates HD signal restoration.

FIG. 7 illustrates a HD video restoration algorithm.

FIG. 8 illustrates pseudo-code for using the HD video restoration algorithm of FIG. 7.

FIG. 9 illustrates an example of HD signal restoration performed on a wirelessly received image.

FIG. 10 illustrates a method for HD audio restoration.

FIG. 11 illustrates an end-to-end system implementation employing data rata reduction techniques with an end-to-end HDCP session.

FIG. 12 illustrated an end-to-end system implementation employing data rate reduction techniques across multiple HDCP sessions.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### I. Introduction

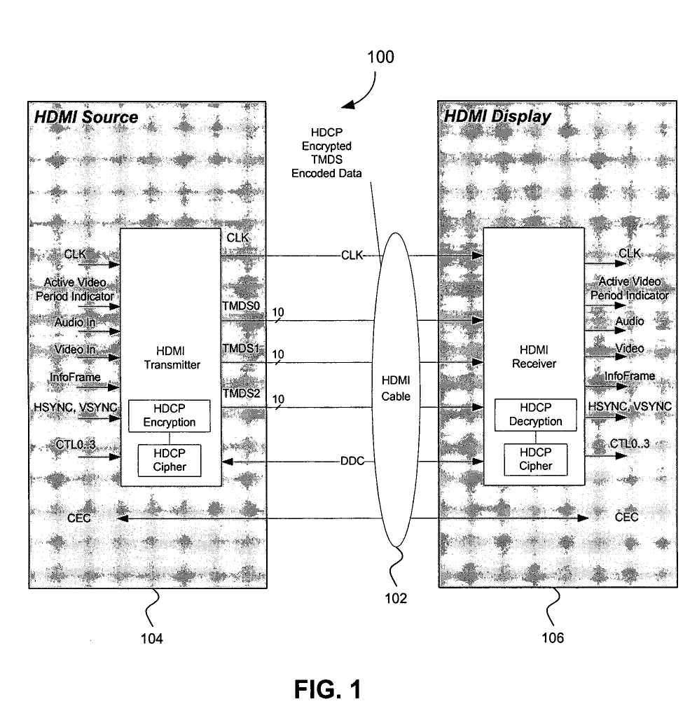

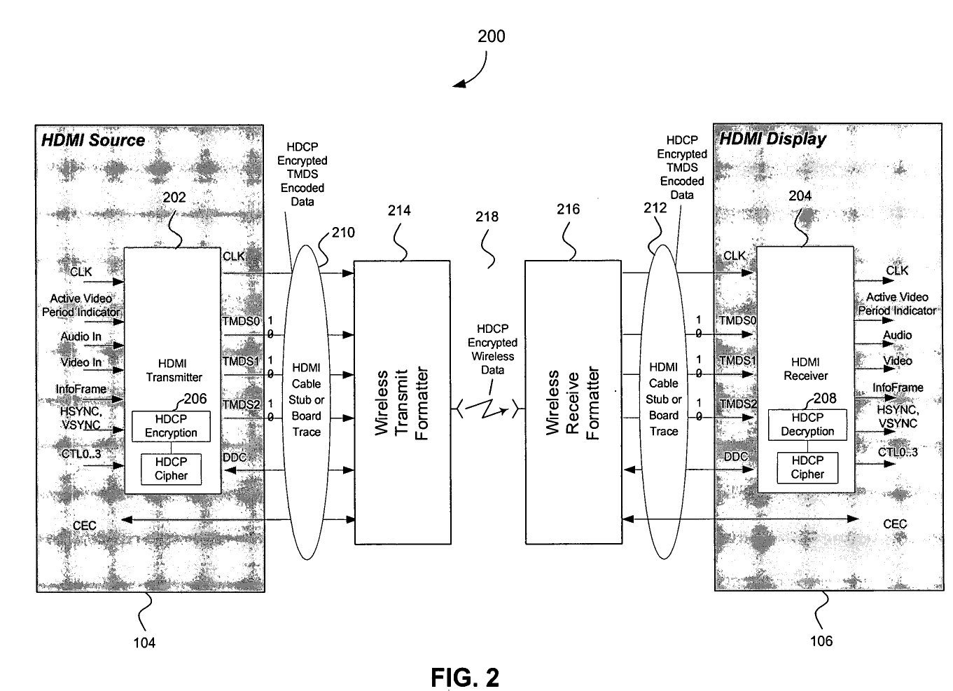

FIG. 2 illustrates a wireless HDMI content delivery system 200 with HDCP encryption, according to an embodiment of the present invention. System 200 replaces the bulky copper cable of system 100 of FIG. 1 with a practical wireless solution enabled using a wireless transmitter 214 at HDMI source 104 and a wireless receiver 216 at HDMI display 106. As would be understood by persons skilled in the art, the wireless implementation of HDMI system 200 can be readily extended to a DVI system, and the following discussion of HDMI system 200 can similarly be applied to a DVI system.

HDMI source 104 includes an HDMI transmitter 202. HDMI transmitter 202 receives audio, video, and control signals, HDCP encrypts the received signals, and transmits the received signals over an HDMI cable stub or board trace 210, conveyed as TMDS signals.

As described above, certain limitations preclude the direct wireless transmission of TMDS-encoded, adequately FEC-protected, HD content. Accordingly, in the HDMI system of FIG. 2, formatters are used at the source and display sides respectively to enable reduction in the data rate required for wireless transmission of HD content.

At the source, a wireless transmit formatter 214 acts on the TMDS-encoded HDCP-encrypted HDMI content to reduce the required data rate while maintaining high content quality. In an embodiment, wireless transmit formatter 214 reduces the data rate using one or more of frame compression, overhead elimination (e.g., overhead due to TMDS), and efficient FEC encoding techniques. Wireless transmit formatter 214 also ensures that used data rate reduction techniques are compatible with HDCP. In an embodiment, wireless transmit formatter 214 is embedded in HDMI source 104. In another embodiment, wireless transmit formatter 214 is connected to HDMI source 104 using an HDMI cable stub. When embedded in HDMI source 104, wireless transmit formatter 214 is connected to the HDMI transmitter within the source using a board trace.

Subsequent to data rate reduction by the wireless transmit formatter, HDCP-encrypted data is transmitted over wireless channel 218. As would be understood by a person skilled in the art, wireless transmit formatter 214 conditions the HDCP-encrypted signals for wireless transmission prior to actual transmission. This includes, for example, digital-to-analog conversion and RF up-conversion.

At the display side, a wireless receive formatter 216 receives the wirelessly transmitted HDCP-encrypted signals. Wireless receive formatter 216 typically performs down-conversion and analog-to-digital conversion on the received signals. In an embodiment, wireless receiver formatter 216 is embedded in HDMI sink 106. In another embodiment, wireless receive formatter 216 is connected to HDMI sink 106 using an HDMI cable stub. When embedded in HDMI sink 106, wireless receive formatter 216 is connected to the HDMI receiver within the sink using a board trace. Wireless receive formatter 216 acts on the wirelessly received content to re-generate the HDCP-encrypted HDMI content. The re-generated content has equal data rate to content before wireless transmit formatting. In an embodiment, wireless receive formatter 216 performs one or more of frame decompression, TMDS encoding, FEC encoding, and HD signal restoration on the received content. Wireless receive formatter 216 then delivers the re-generated content to HDMI display 106. In an embodiment, wireless receiver formatter 216 re-encodes the received HDCP-encrypted signals using TMDS and delivers the re-encoded signals to HDMI display 106 over a HDMI cable stub or board trace 212.

HDMI display 106 includes a HDMI receiver 204, which receives the TMDS encoded signals over HDMI cable stub or board trace 212 and HDCP decrypts the received signals using HDCP decryption module 208, to generate the original video, audio, and control signals. The original video, audio, and control signals are then processed for display by appropriate controllers (not shown) of HDMI display 106.

Embodiments of the present invention, as will be further described below, are directed to methods and systems for enabling the source/sink formatting techniques described above with reference to FIG. 2. These methods and systems include data rate reduction as well as re-generation and correction techniques. Embodiments of the present invention enable secure and efficient wireless transmission of HDCP-encrypted high definition (HD) signals.

### II. Methods for Data Rate Reduction and Regeneration Consistent with HDCP

In the following, methods and systems for data rate reduction and re-generation of wirelessly transmitted HD content will be provided. These methods and systems can be generally divided into the categories of frame compression/decompression, overhead elimination/restoration, and reduced overhead FEC encoding/decoding techniques. Other techniques such as HD signal restoration can be also used to improve the quality of the received HD content.

As will be appreciated by a person skilled in the art based on the teachings herein, embodiments of the present invention may implement any combination of the herein provided techniques and are not limited to the herein described embodiments.

A. Frame Compression/Decompression

One technique to reduce video/audio data rate is using inter-frame and intra-frame compression. This includes, for example, MPEG-2 compression, which is capable of reducing the data rate of 1080p video from more than 3 Gbps to less than 100 Mbps. However, such compression and corresponding decompression add substantial system costs and introduce end-to-end latency that is unacceptable in various applications such as gaming, for example. Furthermore, in wireless transmission, MPEG-2 compressed content quality degrades rapidly due to wireless channels errors; in contrast, uncompressed content and content compressed using only intra-frame compression techniques are much more tolerant of wireless channel errors. In addition, MPEG-2 and other inter-frame compression techniques are not compatible with HDCP, and thus systems employing them may not be acceptable to the MPAA and the FCC.

Nonetheless, as will be described below, there exist other intra-frame compression techniques that are HDCP compatible and that can be used to reduce the data rate of HD content.

i) Downscaling

Downscaling is a compression technique in which a HD formatted (e.g., HDMI/DVI formatted) signal is downscaled to another valid HD signal format upon which HDCP can be applied. In cases where the HD signal is HDCP encrypted, downscaling is preceded by HDCP decryption and followed by HDCP re-encryption. Referring to HDMI system 200, for example, wireless transmit formatter 214 receives a TMDS-encoded HDCP-encrypted HDMI-formatted signal. To downscale the signal, wireless transmit formatter 214 removes the TMDS encoding (TMDS decoding), HDCP-decrypts the signal, and then performs downscaling on the HDMI formatted signal. For example, a 1080p video signal may be downscaled to 720p mode, which requires approximately half the data rate. The downscaled HDMI formatted signal is then HDCP-encrypted prior to wireless transmission. The source formatter may or may not TMDS encode the signal.

ii) Bit Width Reduction

Pixel bit width reduction is a compression technique which can be used to compress video content. Typically, a pixel is represented using 24 bits in an RGB (Red, Green, Blue) color system, with 8 bits for each of the red, green, and blue components of the pixel. It has been proven, however, that the human eye is most sensitive to green, followed by red, and least sensitive to blue. Accordingly, an uneven bit width allocation to RGB components may be used without causing perceived differences for a human eye. In an embodiment, pixel bit widths are allocated to RGB components according to eye sensitivity levels thereto. Further, the uneven bit width allocation allows for a reduction in the total number of bits per pixel, by reducing bit width allocations to less sensed components. For example, 21 bits per pixel may be allocated, to maximize perceived image quality, as 8 bits for the green component, 7 bits for the red component, and 6 bits for the blue component. This bit width reduction results in approximately 12.5% reduction of in video data rate.

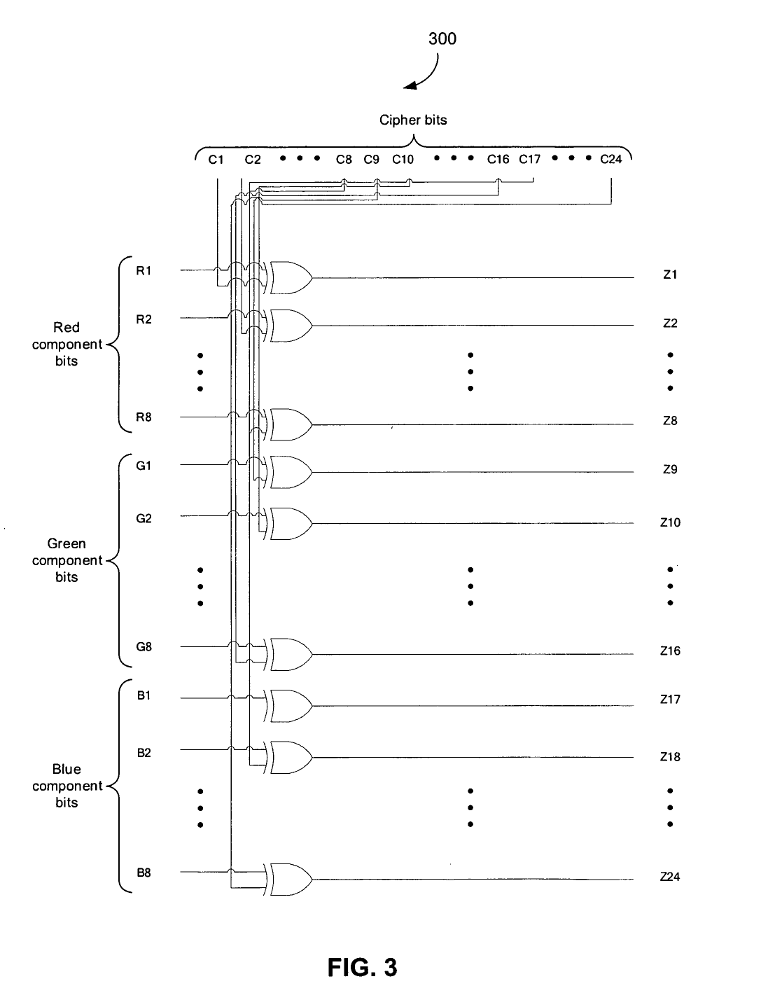

It is noted that pixel bit width reduction is also compatible with HDCP encryption/decryption. FIG. 3 illustrates circuitry 300 for implementing HDCP encryption. Generally, HDCP encryption on a given pixel is performed on a bit by bit basis, by performing an XOR operation on each pixel bit with a respective cipher bit. In FIG. 3, circuitry 300 includes a plurality of XOR gates, with each XOR gate receiving a pixel bit and a corresponding cipher bit and outputting a respective encrypted bit. Inputs R₁, . . . ,R₈, G₁, . . . ,G₈, and B₁, . . . ,B₈ represent pixel bits for the red, green, and blue components, respectively, of a given 24-bit pixel. Inputs C₁, . . . , C₂₄ represent cipher bits typically generated by a cipher generator. In FIG. 2, for example, an HDCP cipher generator is illustrated that provides a cipher to HDCP encryption module 206. Outputs Z₁, . . . , Z₂₄ represent the respective outputs of XOR operations between pixel bits {R₁, . . . ,R₈, G₁, . . . ,G₈, and B₁, . . . ,B₈} and cipher bits C₁, . . . , C₂₄.

In one technique to implement pixel bit width reduction with HDCP, a 24-bit pixel is HDCP encrypted according to the scheme of FIG. 3, but only a subset of output bits Z₁, . . . , Z₂₄ is transmitted. For example, in an embodiment that uses an allocation of 8 bits for green, 7 bits for red, and 6 bits for blue, outputs bits {Z₁, Z₂, Z₃, Z₄, Z₅, Z₆, Z₇, Z₉, Z₁₀, Z₁₁, Z₁₂, Z₁₃, Z₁₄, Z₁₅, Z₁₆, Z₁₇, Z₁₈, Z₁₉, Z₂₀, Z₂₁, Z₂₂} are transmitted but bits Z₈, Z₂₃, and Z₂₄ are not. Note that bits Z₈, Z₂₃, and Z₂₄ correspond to pixel bits R₈, B₇, and B₈, respectively, where bit R₈ is the least significant bit of the red pixel component and bits B₇ and B₈ are the two least significant bits of the blue pixel component.

At the receiver, missing values for Z₈, Z₂₃, and Z₂₄ are inserted, for example, using a fixed pattern (e.g., all zeros, all ones) or a pseudo-random binary sequence (PRBS) generator and combined with the received values. The resulting 24 bit values are then HDCP decrypted. Note that the decrypted bits corresponding to bits R₈, B₇, and B₈ have a 50% probability of being in error, but the other decrypted bits are only in error if uncorrectable transmission errors occurred. However, as noted previously, bits R₈, B₇, and B₈ are not likely to cause any perceived problems, even when they are given erroneous decrypted values.

iii) Component Sub-Sampling

In another video compression technique that exploits the uneven sensitivity of the human eye to different color components, component sub-sampling includes transmitting color components at uneven data rates according to the human eye's sensitivity to the components. For example, given that blue is the least sensed component in the RGB color system, the blue pixel component is transmitted at a lower rate than that of green or red. In an embodiment, the blue pixel component (the pixel bits allocated for blue) is transmitted only every other video frame, while the green and red pixel components are transmitted every frame. Other variations of this technique of component sub-sampling are also possible as may be understood by a person skilled in the art.

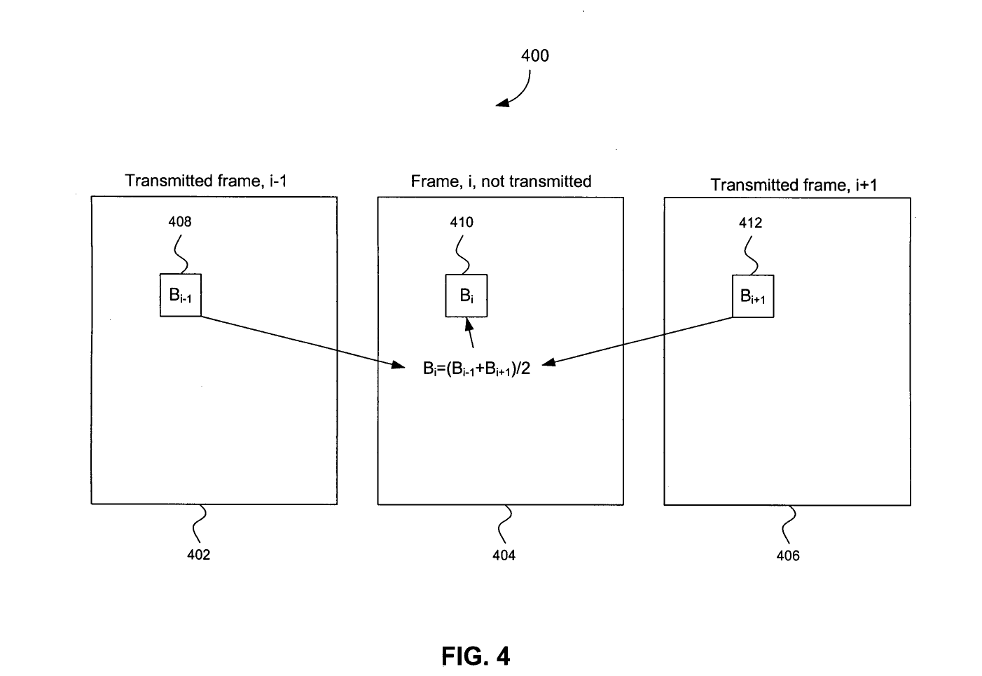

At the receiver side, the non-transmitted blue (or other color component in other embodiments) pixel data is calculated from adjacent transmitted blue pixel components. This is illustrated in FIG. 4, which illustrates a method 400 for calculating blue pixel data for non-transmitted blue pixel component Bᵢ 410 in frame i 404 as an average of transmitted pixel components Bᵢ₋₁ 408 and Bᵢ₊₁ 412 in adjacent frames i−1 402 and i+1 406, respectively.

Component sub-sampling is compatible with HDCP encryption. For example, referring to FIG. 3, in a component sub-sampling method that transmits the blue pixel component every other frame, output bits Z₁₇, . . . , Z₂₄ that correspond to blue pixel component HDCP encryption would be transmitted every other frame.

iv) Color Space Conversion and Component Down-Sampling

A further data reduction technique includes using color space conversion followed by component down-sampling. In an embodiment, pixel data is converted from an RGB system to a YCrCb 4:4:4 system. This can be done in many ways. For example, the YCbCr 4:4:4 format, defined for standard-definition television in the ITU-R BT.601 (formerly CCIR 601) standard for use with digital component video, is derived from a corresponding RGB space using a transform according to:

Y=(0.257*R)+(0.505*G)+(0.098*B)+16;

Cr=(0.439*R)+(0.368*G)−(0.071*B)+128;

Cb=−(0.148*R)−(0.291*G)+(0.439*B)+128. (1)

The resulting values of Y, Cr, and Cb would then be rounded to the desired fixed point precision and saturated to prevent overflow. Someone skilled in the art would recognize that many other transforms such as that yielding the YCbCr format specified in the ITU-R BT.709 standard could alternatively be used.

In a YCrCb color system, Y represents the luma component and is equivalent to grayscale information, Cr represents the red chroma component, and Cb represents the blue chroma component. A YCrCb 4:4:4 system transmits the three color components at equal rates.

As in the RGB system, the human eye is unevenly sensitive to components in the YCrCb system. Typically, the human eye is much more sensitive to luma variations than to chroma variations. Accordingly, this difference in sensitivity can be exploited to reduce the transmitted frame data rate by sampling luma and chroma components at different rates. A 4:2:2 YCrCb system, for example, down-samples chroma components to half the rate of the luma component, thereby resulting in an approximately 33% reduction in the required frame data rate. Similarly, a 4:2:0 YCrCb system down-samples chroma components to one-quarter the rate of the luma component, thereby resulting in 50% reduction in the required frame data rate.

Conversion from a 4:4:4 YCrCb system to a 4:2:0 YCrCb system can be done in many ways. For example, starting with a frame of N×M Cr and Cb samples extracted from a YCrCb 4:4:4 image, a component down-sampled frame of size N/2×M/2 in YCrCb 4:2:0 format can be generated. One approach is to average 2×2 groups of samples from the N×M frame to form samples of the down-sampled N/2×M/2 frame. In mathematical notation, provided with respect to Cr samples (for Cb samples, replace Cr with Cb in the equation), this is given by:

$$Cr ( x , y ) = \frac{\begin{matrix}\tilde{C} r ( 2 x - 1 , 2 y - 1 ) + \tilde{C} r ( 2 x - 1 , 2 y ) + \\ \tilde{C} r ( 2 x , 2 y - 1 ) + \tilde{C} r ( 2 x , 2 y )\end{matrix}}{4} \qquad ( 2 )$$

where Cr(x,y) and \tilde{C}r(x,y) respectively represent Cr samples at row x and column y of the down-sampled N/2×M/2 frame and the original N×M frame, and where x and y are integer numbers starting at 1. Note that in equation (2), rounding and saturation would be used to provide the desired precision.

HDCP encryption is then implemented as illustrated in FIG. 3 on the color-space converted, component down-sampled, YCrCb values.

At the receiver side, HDCP decryption is first applied on the received down-sampled YCrCb values. Subsequently, the unencrypted down-sampled values are up-sampled to calculate values for non-transmitted components.

Many approaches are available for up-sampling a down-sampled frame. For example, given iε{1,2, . . . , Nr/2}, jε{1,2, . . . , Nc/2}, where Nr and Nc respectively represent the desired numbers of rows and columns of the up-sampled frame, equations (3)-(6) below can be used to calculate values for non-transmitted components in the down-sampled frame (for Cb samples, replace Cr with Cb in the equations):
Odd row, odd column:

\tilde{C}r(2i−1,2j−1)=9*Cr(i,j)+3*Cr(i−1,j)+3*Cr(i,j−1)+Cr(i−1,j−1) (3)
Even row, odd column:

\tilde{C}r(2i,2j−1)=9*Cr(i,j)+3*Cr(i,j+1)+3*Cr(i−1,j)+Cr(i−1,j+1) (4)
Odd row, even column:

\tilde{C}r(2i−1,2j)=9*Cr(i,j)+3*Cr(i,j−1)+3*Cr(i+1,j)+Cr(i+1,j−1) (5)
Even row, even column:

\tilde{C}r(2i,2j)=9*Cr(i,j)+3*Cr(i+1,j)+3*Cr(i,j+1)+Cr(i+1,j+1) (6)

where \tilde{C}r(x,y) and Cr(x,y) in equations (3)-(6) respectively represent Cr samples at row x and column y of the up-sampled frame and the down-sampled frame. Note that depending on the position in the frame of a non-transmitted component, one of equations (3)-(6) will be used to calculate a value for that component. Also, as in equation (2), rounding and saturation would be used to provide the desired precision.

The up-sampled YCrCb 4:4:4 frame can then be re-converted, if desired, into an RGB system, according to the following operations:

C=Y;

D=Cr−128;

E=Cb−128;

R=1.164*C+1.596*E;

G=1.164*C−0.392*D−0.813*E;

B=1.164*C+2.017*D.

Rounding and saturation would be used to provide the desired precision. Further, the operations assume a YCrCb 4:4:4 format as defined for standard-definition television use in the ITU-R BT.601 (formerly CCIR 601) standard. If an alternative RGB to YCrCb transformation is employed, a correspondingly alternative transformation would be needed to convert back from YCrCb to RGB.

B. TMDS Encoding Elimination/Restoration

Another approach for reducing the required data rate for the purpose of wireless transmission is to eliminate any overhead unnecessary for wireless transmission but used in typical HD content transmission.

As described above, one major overhead constituent in HD content (HDMI/DVI) transmission is due to TMDS signaling. This overhead is mainly for supporting DC-balancing and transition minimization over copper, but provides little gain for wireless HD content transmission. TMDS is also less than optimal in other respects for wireless HD content transmission.

It is desirable therefore to eliminate TMDS encoding, reducing the HD content to baseband form, in order to reduce the data rate for the purpose of wireless transmission. In an embodiment, a TMDS decoder is used at the content source to TMDS decode, prior to wireless transmission, TMDS encoded HD signals received over an HD (HDMI/DVI) cable stub or board trace. Correspondingly, at the content sink, a TMDS encoder is used to TMDS re-encode the wirelessly transmitted signals, before providing them over an HD cable stub or board trace to the content sink. Further description of methods and systems to enable TMDS elimination/restoration for wireless transmission can be found in commonly owned U.S. patent application Ser. No. 11/117,467 filed Apr. 29, 2005, and entitled “System, Method and Apparatus for Wireless Delivery of Content from a Generalized Content Source to a Generalized Content Sink.”

C. Efficient FEC, UEP, and HD Signal Restoration

Forward error correction (FEC) is another facet of conventional HD content transmission that can be enhanced to reduce the data rate required for wireless transmission of HD content.

In one aspect, it is desirable to reduce the amount of overhead by selecting efficient FEC codes for wireless transmission. At the same time, it is also desirable, whenever possible without degrading content quality, to exploit redundancy in HD content (audio/video) to be able to relax the FEC code requirements, further reducing its required overhead. This is described herein as HD signal restoration. Additionally, as a further technique to reduce FEC overhead, error correction may be applied unequally to portions of HD content, emphasizing protection to significant portions of information and lessening protection to less significant portions. This is described herein as Unequal Error Protection (UEP).

It is noted that the above mentioned FEC overhead reduction techniques need to be implemented while maintaining over-the-air HDCP encryption of HD content.

i) Efficient Forward Error Correction (FEC)

TMDS employs a BCH (Bose, Ray-Chaudhuri, Hocquenghem) code for error correction to protect portions of HD content and control data. Other portions of HD content are not protected with any FEC. BCH codes, however, are significantly inferior to other types of codes such as low parity check codes (LDPC), for example, which provide greater error protection at lower overhead. Accordingly, for the purpose of reducing the wireless data rate, the conventionally used BCH code can be replaced with a more efficient code for over-the-air wireless transmission. In addition, to guard against wireless channel errors, the more efficient code can also be applied to HD content that is not protected with any FEC in TMDS.

In an embodiment, an FEC module is used at the content source to FEC decode HD content protected using the BCH code and to re-encode this and the unprotected HD content with a more efficient code, prior to wireless transmission. At the receiver side, a corresponding FEC module is used to decode the wirelessly transmitted content protected with the more efficient code and to re-encode the HD content using the original BCH code, before providing it to the content sink over an HD (HDMI/DVI) cable stub or board trace.

Further description of methods and systems to enable efficient FEC for HD content transmission can be found in commonly owned U.S. patent application Ser. No. 11/117,467 filed Apr. 29, 2005, and entitled “System, Method and Apparatus for Wireless Delivery of Content from a Generalized Content Source to a Generalized Content Sink.”

ii) Unequal Error Protection (UEP)

High definition (HD) content (video/audio) contains information bits that are of unequal importance. As such, at the content sink (e.g., display), the perceived content quality (e.g., image quality) is impacted more by the most significant bits (MSBs) of information than by the least significant bits (LSBs). A bit error occurring on a MSB, accordingly, is also more noticeable than a bit error occurring on a LSB. This is generally true for both video and audio.

Since bit errors are unavoidable in wireless transmission, the overall content quality (image and audio quality) is best maintained by maximizing the probability that bit errors, if they happen, occur on information bits corresponding to LSBs of transmitted content. As will be described below, this can be achieved by exploiting certain facts about the nature of RF and channel impairment mitigation algorithms (e.g., channel equalization) that are typically used in digital communication systems and using digital communication techniques such as OFDM (orthogonal frequency division multiplexing), LDPC codes, and MIMO that support providing a subset of the information with greater error protection.

In one aspect, digital communication systems often yield information bit estimates whose reliability varies over time in a predictable way. For example, a communications receiver reconstructs transmitted information bits after mitigating against RF and channel impairments. However, often these mitigation algorithms are biased in favor of certain information bits in a statistically predictable way. In other words, the error rate on some information bits is predictably lower than for other information bits. For example, in systems employing OFDM, error mitigation is least effective for data carried on sub-carriers at the edges of the RF band. This typically occurs for a variety of reasons including, 1) the fact that often filter roll-off from the band center causes outer sub-carriers to have lower RF gain and/or higher noise figure; 2) some compensation algorithms (e.g., those dealing with sample clock offsets between the transmitter and the receiver) perform worse at band edges; and 3) band edges are often more susceptible to adjacent band interference and aliasing. Therefore, in OFDM, it is expected that the demodulated information bit reliability will be greater for sub-carriers not located on a band edge.

In another aspect, forward error correction (FEC) is often predictably uneven across information bits. As described in commonly owned U.S. patent application Ser. No. 11/117,467, given a fixed amount of overhead, LDPC codes provide improved performance compared to BCH codes or convolutional codes, for the purpose of protecting HD content. In addition, an irregular LDPC code yields a bit error rate that varies deterministically depending on the placement of information bits in the code input.

In a further aspect, MIMO techniques can be used to force UEP of transmitted bits. For example, transmit diversity may be implemented on MSBs but not on LSBs.

Accordingly, based on the above description, UEP can be exploited in order to maintain high quality of content while being able to relax FEC overhead, thereby allowing for a reduction in wireless data rate. In the following, a scheme for exploiting UEP for the purpose of wireless transmission of HDCP-encrypted HD (HDMI/DVI) content, according to an embodiment of the present invention, is provided.

At a high-level, the scheme includes mapping the MSBs of content (whether audio or video) onto the most reliable bit positions, as provided by the UEP being implemented. For example, in the case of UEP enabled by OFDM, this includes mapping the MSBs to sub-carriers not located on a band edge. Note that in the case that UEP is enabled by several elements (e.g., OFDM, LDPC, etc.) variations of UEP exploitation may exist, as would be understood by a person skilled in the art. An exemplary embodiment according to the present invention is provided below.

Assuming an OFDM system with 256 sub-carriers of which 240 are used for data or pilots, the 240 sub-carriers are divided into 224 for data and 16 for pilots. The 224 sub-carriers are then further divided into 204 “good” sub-carriers and 20 “bad” sub-carriers. The division of sub-carriers is done according to proximity to edges of the RF band. Similarly, content (audio and video) is divided into three groups of MSBs, “middle” bits, and LSBs.

The mapping of bits to sub-carriers and the application of FEC is then done as follows:
1) The LSBs are directly placed onto “bad” sub-carriers, without any additional error correction coding; and
2) The “middle” bits and the MSBs are encoded using an irregular LDPC, and the resulting bits are placed on the “good” sub-carriers. Note that in the LDPC encoding, the MSBs are placed at bit locations with the lowest expected bit error rate while the “middle” bits are placed at bit locations with higher expected bit error rate.

Note that the above scheme significantly reduces FEC overhead by denying it to LSBs and focusing it instead on MSBs and “middle” bits. This, coupled with optimally positioning important bits onto “good” sub-carriers, ensures that adequate transmitted content quality is maintained.

It should be apparent to those skilled in the art that the above scheme can be readily extended by further dividing OFDM sub-carriers into more than two classes. Further, the scheme may be provided a third UEP dimension by implementing MIMO techniques (e.g., transmit diversity for MSBs).

iii) HD Signal Restoration

It is desirable to maintain high quality HD content, while employing the above mentioned data rate reduction techniques. One particular approach to achieve that is through HD signal restoration at the receiver, whereby redundancy in received HD content is exploited to reduce the impact of information bit errors. HD signal restoration techniques may be very powerful, concealing in some cases error rates exceeding 20% to maintain high quality audio and/or video quality.

Generally, HD signal restoration uses data that is known to be highly reliable to correct data that is most likely received in error.

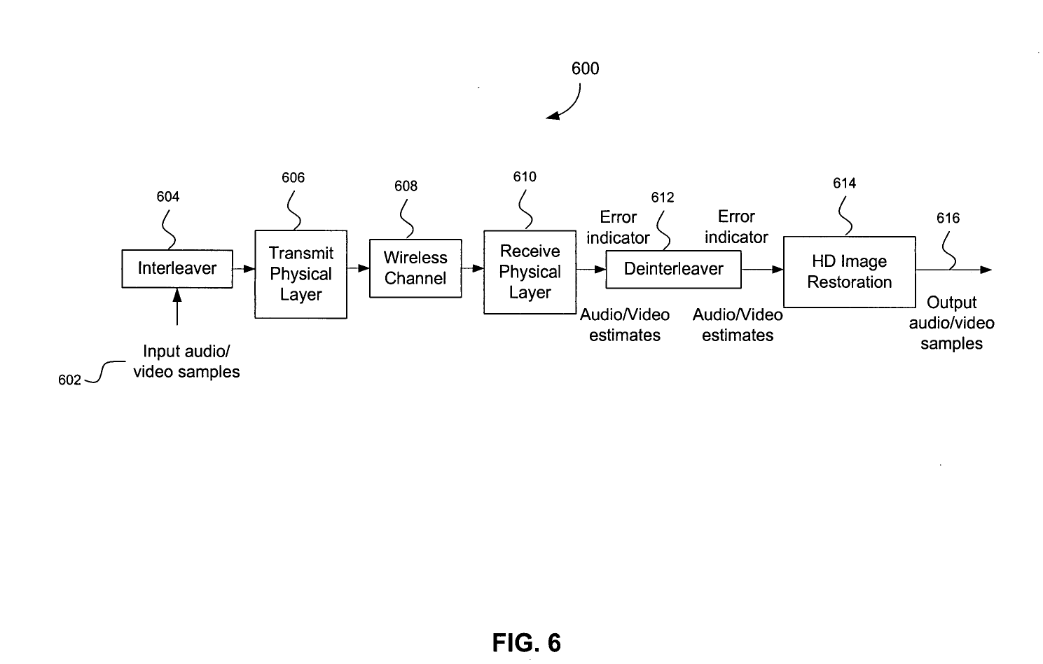

FIG. 6 illustrates an example HD content wireless communications chain 600, with particular focus on components used for the purpose of enabling efficient HD signal restoration.

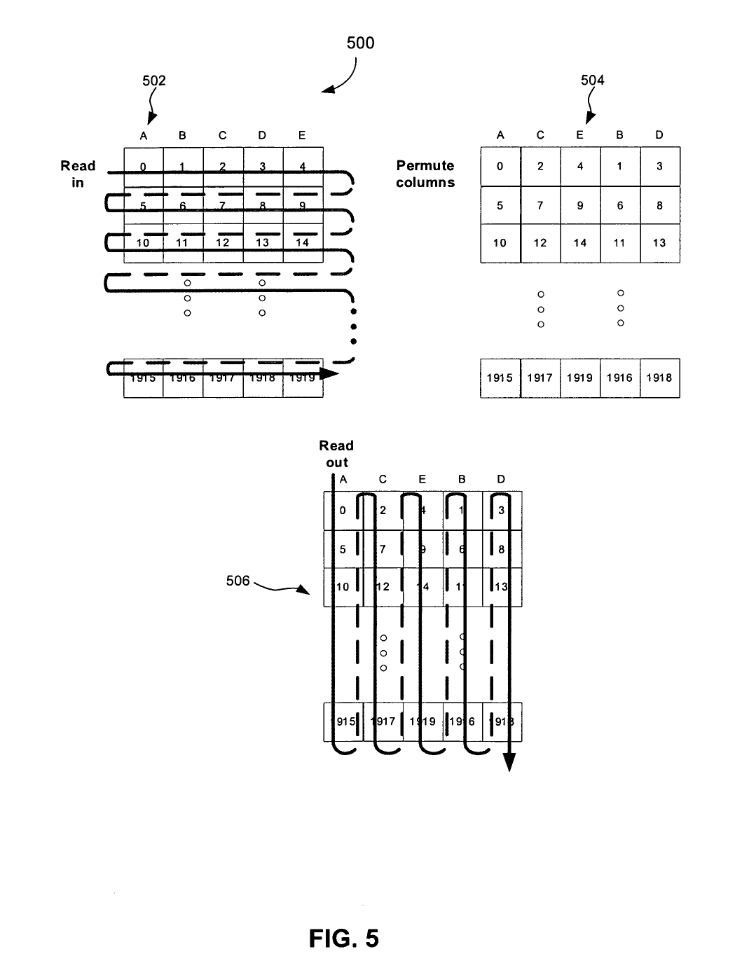

Note, for example, interleaver 604 and de-interleaver 612 at either end of communications chain 600, which are used here to reduce the probability of error “bursts” being received at the receiver. Interleaving audio samples, for example, ensures that temporally neighboring portions of audio are not consecutively transmitted over the wireless channel. Accordingly, given an error burst, the probability of temporally neighboring audio samples each being received in error is significantly reduced. Similarly, interleaving video samples ensures that neighboring samples in each frame are not consecutively transmitted over the wireless channel. As a result, a burst of errors will not cause a block of neighboring samples to be received in error. De-interleaver 612 operates correspondingly to interleaver 604 to re-group received content samples in correct order, to re-generate original audio and/or video samples 602. FIG. 5 illustrates an example interleaving method 500 based on a 5×N block interleaver. In step 502, the interleaver reads in a frame having a line length of 5N in a row-by-row fashion. In step 504, the interleaver randomly permutes columns of the read frame, and then reads it out column-by-column in step 506.

Referring back to FIG. 6, another component for enabling efficient HD signal restoration resides in receive physical layer 610, where it is important for receive physical layer 610 to identify content (audio and/or video) samples that are likely to be in error. Several well-known methods exist that can be used to achieve that including, for example, applying cyclic redundancy check (CRC) codes on the transmitted data to enable detection of errors at the receiver.

HD restoration module 614 is directly concerned with performing HD signal restoration on received content samples and outputting enhanced audio/video samples. In the following, exemplary HD signal restoration algorithms for video and audio will be described. It is assumed that these algorithms receive indication of received samples in error from other components at the receiver. The two algorithms will be described independently herein, but as would be understood by a person skilled in the art, it is considered to be within the scope of this invention that the algorithms are combined into a single algorithm providing HD signal restoration concurrently for video and audio.

The HD video restoration algorithm operates by considering, in an embodiment, a 5×5 pixel matrix surrounding the pixel likely to be in error. Using the 8 nearest neighbor pixels, edge weights and associated candidate pixel values are calculated according to formulas of the algorithm for 8 edges. In other embodiments, the size of the pixel matrix as well as the number of neighbor pixels considered may vary. These calculated edge weights and associated candidate pixel values are then used in an algorithm (a pseudo-code representation of which will be described below) to assign a value to the pixel in error.

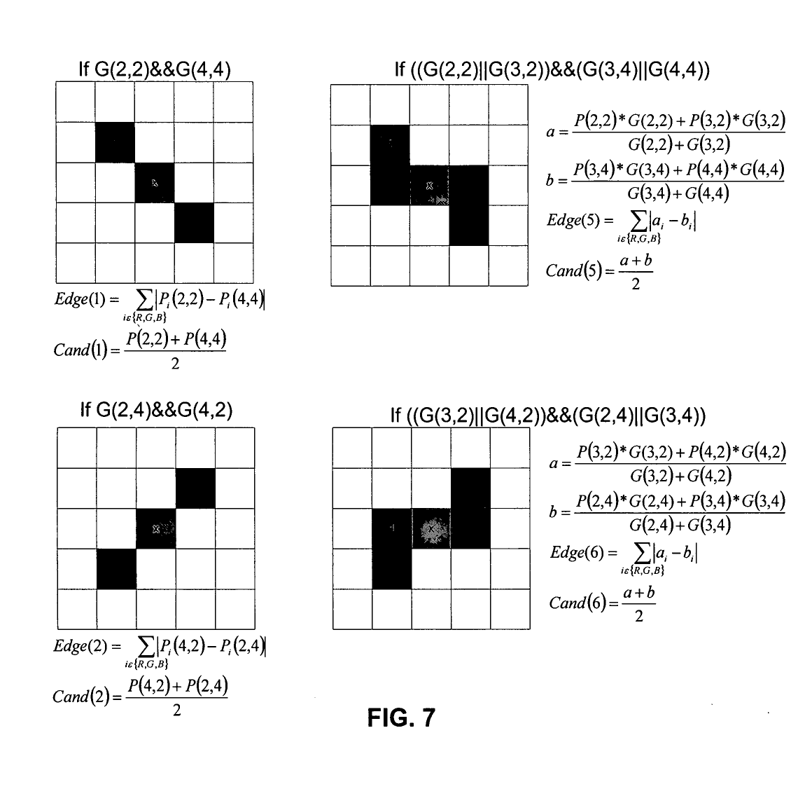

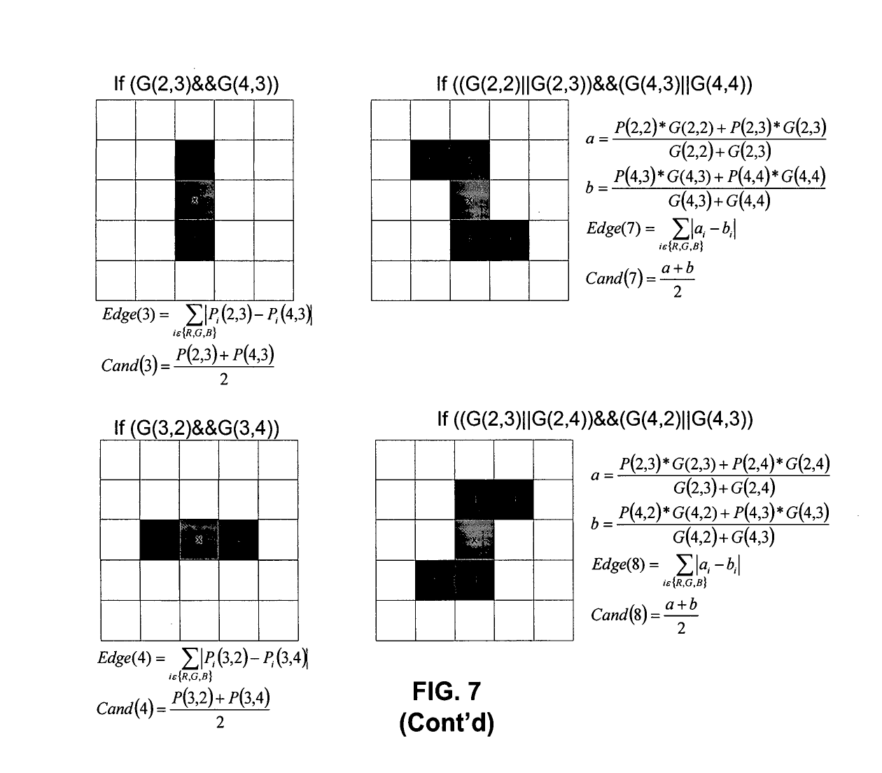

FIG. 7 illustrates the calculation of edge weights and associated pixel values in accordance with the above described embodiment and assuming the use of RGB pixel data. Variations of the illustrated technique using pixel data in other HDMI/DVI formats (e.g., YCrCb) and/or operating the algorithm on individual pixel constituents (e.g., operating separately on R, G, and B) are also possible as may be understood by a person skilled in the art. An edge is considered valid if an associated condition is true. For example, referring to FIG. 7, Edge(1) is valid if the condition (G(2,2) && G(4,4)) is true, where G(x,y)=1 if the pixel at location (x,y) is good and G(x,y)=0 if the pixel is bad, as determined by the physical layer. Accordingly, Edge(1) is valid if both pixels at (2,2) and (4,4) are good pixels.

When an edge is valid, the value of its associated edge weight is calculated based on the pixel values of pixels that appear in the associated validity condition. Similarly, candidate pixel values associated with the edge weights are calculated based on the pixel values of pixels that appear in the validity condition. Formulas for these calculations are illustrated in FIG. 7, where P(x,y) is the pixel representation at location (x,y), P_{R}(X,y) represents the red pixel component, P_{G}(X,y) represents the green pixel component, and P_{B}(X,y) represents the blue pixel component. Also, where it appears, P(x,y)+P(a,b) represents the sum of the pixels at locations (x,y) and (a,b), where the sum is performed on a component-by-component basis. [P(x,y)+P(a,b)]/2 represents the component-by-component sum divided by 2 with rounding (no saturation is necessary).

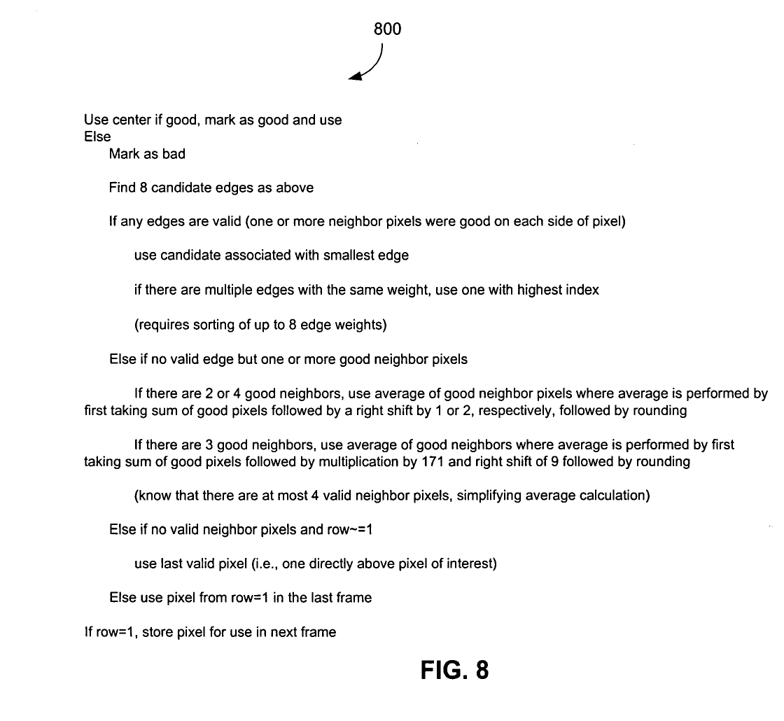

Based on the calculations described above, an algorithm is used to assign a value to the erroneous pixel. A pseudo-code representation 800 of the algorithm is illustrated in FIG. 8, and works as follows:

If any edges are valid (i.e., one or more neighbor pixels are good on each side of an erroneous pixel), then use the candidate pixel value associated with smallest edge weight. If multiple valid edges have equal weight, then use the candidate pixel value associated with the edge with the highest index.

Otherwise, if there are no valid edges, but at least one good neighbor pixel of the erroneous pixel (note that the maximum number of good neighbors in this case may be 4), then 1) if there are 2 or 4 good neighbors, the erroneous pixel value is calculated as average of good neighbor pixel values, where said average is performed by taking the sum of the good neighbor pixel values followed by a right shift by 1 or 2 (depending on whether 2 or 4 neighbors are used), followed by rounding; 2) if there are 3 good neighbors, the erroneous pixel value is calculated as average of good neighbor pixel values, where said average is performed by taking the sum of the good neighbor pixel values followed by multiplication by 171 and right shift of 9, followed by rounding.

Otherwise, if there are no valid edges or good neighbors and if the erroneous pixel is not in row 1 of the frame, assign the erroneous pixel the value of the last valid pixel (i.e., one directly above it). If it is in row 1, assign the erroneous pixel the value of same pixel position in previous frame. This requires that the assigned pixel value be stored whenever the pixel is in row 1, regardless of which of the above conditions of the pseudo-code are true.

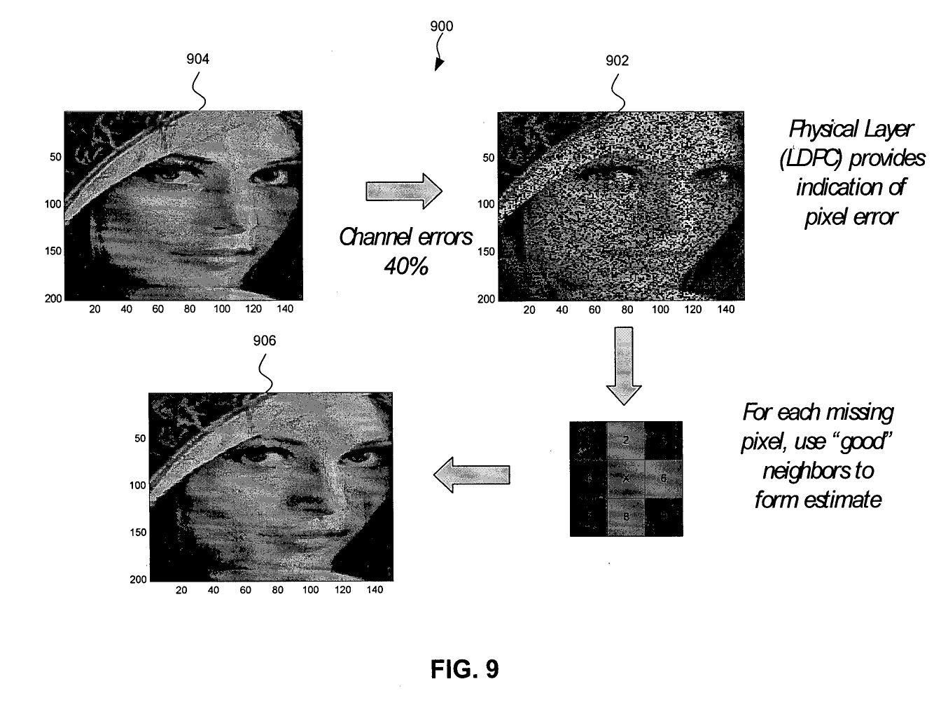

FIG. 9 illustrates the performance of the above described HD signal restoration algorithm when applied to a wirelessly transmitted image 904. It is assumed that the probability of channel errors is approximately 40% and that the physical layer at the receiver uses an LDPC decoder and CRC checks to provide indication of erroneous pixels to the HD signal restoration algorithm. As described above, the algorithm works by assigning estimate values to erroneous and/or missing pixels using “good” neighbor pixels thereof. A comparison of the original transmitted image 904 and a restored image 906 at the receiver in view of a degraded received image 902 highlights the effectiveness of the algorithm.

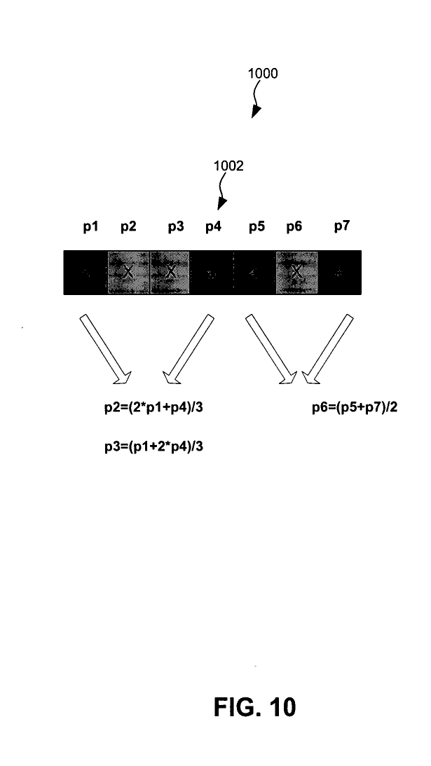

FIG. 10 illustrates an example method 1000 for HD signal restoration for audio content. The method assumes that the physical layer indicates erroneously received samples to the HD signal restoration algorithm. In an embodiment, HD signal restoration is achieved by interpolating “good” samples closest in time to an erroneous sample, to calculate an estimate value for the erroneous value. Typically, a “good” sample prior to the erroneous sample and another “good” sample after the erroneous sample are used. Several interpolation techniques may be used as would be understood by a person skilled in the art. In an embodiment, higher weight is given to the closest “good” neighbor of the erroneous sample. FIG. 10 illustrates several examples with respect to a received sequence of audio samples p₁, p₂, . . . , p₇, where samples p₂, p₃, and p₆ are received in error. Note that an estimate for p₂ is calculated as a weighted average of pixels p₁ and p₄, where pixel p₁ being closer to p₂ than p₄ is given twice the weight in the average calculation. This is similarly done in the case of p₃, i.e., p₄ is given twice the weight of p₁ in the average calculation. For p₆, immediately adjacent pixels p₅ and p₇ are averaged using equal weights.

### III. Example End-to-End System Implementations

The previous section presented several individual methods for secure and efficient wireless transmission of HDCP-encrypted HDMI/DVI signals. This section provides two examples of how these methods can be combined together to provide an end-to-end system implementation. However, as would be understood by a person skilled in the art, many other combinations are possible.

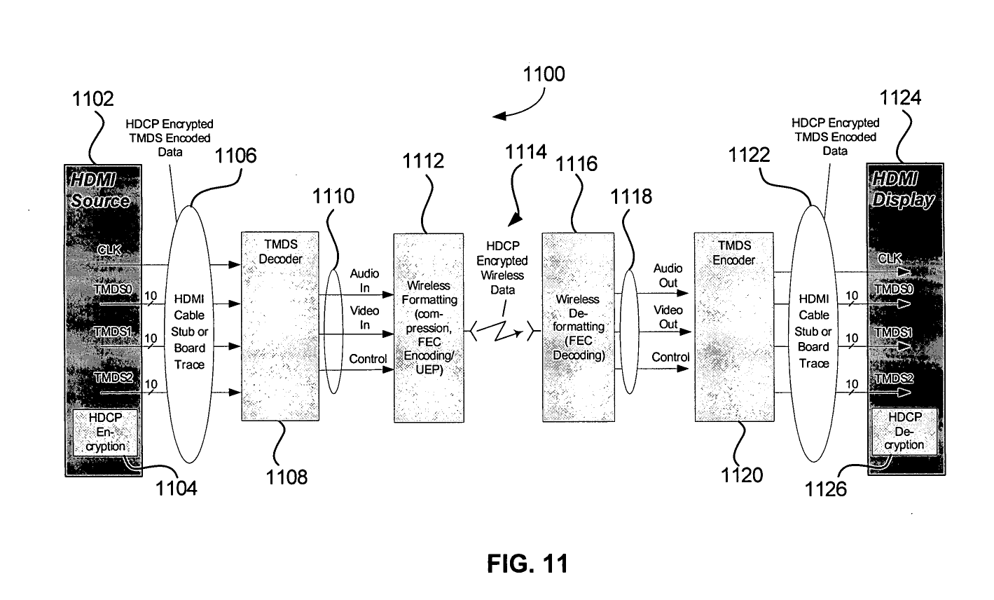

In one embodiment, illustrated in FIG. 11 as system 1100, a single, end-to-end, HDCP session is employed, i.e., HDCP encryption and decryption are performed end-to-end. Referring to system 1100, HDCP encryption module 1104 performs HDCP encryption at HDMI source 1102 and HDCP decryption module 1126 performs HDCP decryption at HDMI display 1124. For ease of illustration, DDC and CEC exchanges are not shown in FIG. 11.

Note that in system 1100, unencrypted audio and/or video are unavailable outside HDMI source 1102 and HDMI display 1124. This precludes the use of compression techniques such as downsampling, color space conversion, component sub-sampling, component down-sampling, and HD image restoration that need to operate on unencrypted data.

However, pixel bitwidth reduction can still be used. In system 1100, HDMI source 1102 performs HDCP encryption on incoming audio, video, and control signals and generates TMDS encoded HDCP encrypted data 1106. HDMI source 1102 then provides TMDS encoded HDCP encrypted data 1106 across an HDMI cable stub or board trace 1106 to a TMDS decoder 1108.

TMDS decoder 1108 converts TMDS encoded data 1106 back to audio, video, and control signals 1110 which are passed to a wireless formatter 1112. Wireless formatter 1112 operates on signals 1110 to reduce the number of bits required to represent video content in signals 1110 using pixel bitwidth reduction. Wireless formatter 1112 then performs FEC encoding and UEP on the bit reduced signals and converts the resulting signals for wireless transmission to generate HDCP encrypted wireless data signals 1114.

At the receiver side, a wireless de-formatter 1116 receives signals 1114 and demodulates them for further digital processing. Wireless de-formatter 1116 performs FEC decoding and inserts either a fixed or a pseudo-random data pattern for bits that were reduced by wireless formatter 1112 using pixel bitwidth reduction. Wireless de-formatter 1116 then passes decoded audio, video, and control signals 1118 to a TMDS encoder 1120. TMDS encoder 1120 converts signals 1118 for transmission over an HDMI cable stub or board trace 1122 to HDMI display 1124. HDMI display 1124 performs HDCP decryption using HDCP decryption module 1126 to retrieve the original audio, video, and control signals.

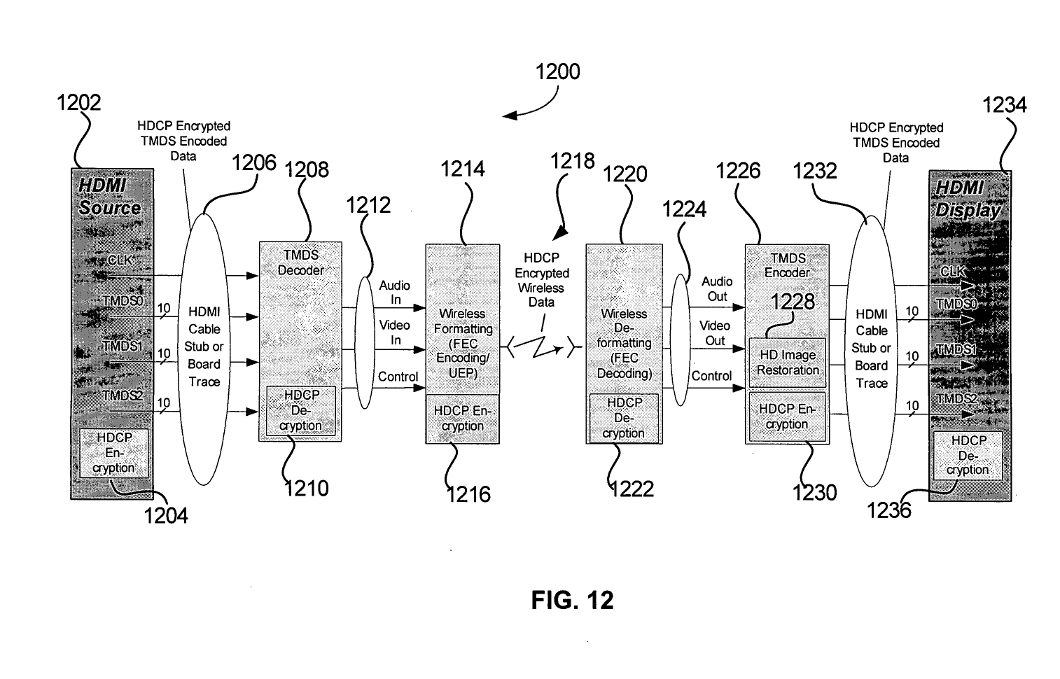

In another embodiment, illustrated in FIG. 12 as system 1200, three separate HDCP encryption and decryption sessions are performed in the end-to-end system. For ease of illustration, DDC and CEC exchanges are not shown in FIG. 12.

The first HDCP encryption/decryption session occurs between HDMI source 1202 and TMDS decoder 1208. HDMI source 1202 receives audio, video, and control signals, which it encrypts using HDCP encryption module 1204. HDMI source 1202 then TMDS encodes the HDCP encrypted signals and provides them to a TMDS decoder 1208 across a HDMI cable stub or board trace 1206. TMDS decoder 1208 converts the received TMDS signals to generate audio, video, and control signals and performs HDCP decryption on the generated signals using HDCP decryption module 1216. The resulting signals 1212 are decrypted audio, video, and control signals, which are passed to a wireless formatter 1214. Wireless formatter 1214 reduces the number of bits require to represent video content in signals 1212 to generate bit reduced data. Wireless formatter 1214 may use any combination of pixel bitwidth reduction, downscaling, component subsampling, color space conversion, and component down-sampling.

The second HDCP encryption/decryption session is carried between wireless formatter 1214 and wireless de-formatter 1222. Wireless formatter 1214 performs HDCP encryption on the bit reduced data using HDCP encryption module 1216 to generate encrypted signals. Wireless formatter 1214 then performs FEC encoding and UEP on the encrypted signals and modulates the resulting signals for wireless transmission as HDCP encrypted wireless signals 1218. At the receiving end, wireless de-formatter 1220 receives wireless signals 1218 and demodulates them for further digital processing. Wireless de-formatter 1220 then performs FEC decoding on the demodulated signals to generate HDCP encrypted audio, video, and control signals. Also, if pixel bitwidth reduction was applied at wireless formatter 1214, wireless de-formatter 1220 inserts either a fixed or a random data pattern for bits that were reduced by wireless formatter 1214. Wireless de-formatter 1220 then performs HDCP decryption on the HDCP encrypted signals using HDCP decryption module 1222, before passing them as audio, video, and control signals 1224 to a TMDS encoder 1226. TMDS encoder 1226 performs HD image restoration on audio, video, and control signals 1224 using HD image restoration module 1228, to generate restored samples.

The third HDCP encryption/decryption session occurs between TMDS encoder 1226 and HDMI display 1224. After performing HD image restoration, TMDS encoder 1226 HDCP encrypts the restored samples using HDCP encryption module 1230. TMDS encoder 1226 then encodes the encrypted restored samples to generate TMDS encoded signals, which are transmitted over a HDMI cable stub or board trace 1232 to HDMI display 1234. HDMI display 1234 receives the TMDS encoded HDCP-encrypted restored samples, performs HDCP decryption on them using HDCP decryption module 1236, and passes the unencrypted restored samples for display processing.

Note that in system 1200, unencrypted audio and video are available at wireless formatter 1214 and TDMS encoder 1226, allowing the use of compression techniques such as downsampling, color space conversion, component sub-sampling, component down-sampling, and HD image restoration. Also, as would be understood by a person skilled in the art, some of the above described operations can be performed in a different order to what is described above and still yield the same overall result. For example, pixel bitwidth reduction at wireless formatter 1214 may be performed before HDCP decryption.

### IV. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for enabling secure and efficient wireless transmission of high definition (HD) content, comprising:
(a) receiving encoded, encrypted HD content;
(b) decoding said received HD content;
(c) reducing a number of bits required to represent said HD content;
(d) formatting said bit reduced HD content for wireless transmission;
(e) transmitting said formatted HD content;
(f) receiving and de-formatting said transmitted HD content; and
(g) encoding said HD content.

2. The method of claim 1, further comprising:
(h) decrypting said decoded HD content after step (b); and
(i) re-encrypting said bit reduced HD content after step (c).

3. The method of claim 1, wherein step (c) comprises reducing a number of bits required to represent decrypted content.

4. The method of claim 1, wherein step (c) comprises reducing a number of bits required to represent encrypted content.

5. The method of claim 1, further comprising:
(h) decrypting said HD content prior to step (g);
(i) performing HD signal restoration on said decrypted HD content; and
(j) re-encrypting said restored HD content.

6. The method of claim 2, further comprising:
(j) decrypting said HD content prior to step (g);
(k) performing HD signal restoration on said decrypted HD content; and
(l) re-encrypting said restored HD content.

7. The method of claim 1, wherein said HD content includes HDMI (High Definition Media Interface) content.

8. The method of claim 1, wherein said HD content includes DVI (Digital Video Interface) content.

9. The method of claim 2, wherein said encrypting and decrypting are performed using HDCP (High-Definition Content Protection).

10. The method of claim 1, wherein step (c) is performed using HDCP (High-Definition Content Protection) compatible techniques.

11. The method of claim 1, wherein step (c) comprises frame compression of said decrypted HD content.

12. The method of claim 11, wherein said frame compression comprises performing one or more of downscaling, pixel bit width reduction, component down-sampling and color space conversion of said HD content.

13. The method of claim 2, wherein step (c) comprises performing one or more of downscaling, pixel bit width reduction, component down-sampling and color space conversion of said HD content.

14. The method of claim 1, wherein said HD content received in step (a) is encoded using TMDS (Transition Minimized Differential Signaling).

15. The method of claim 1, wherein step (d) comprises applying forward error correction (FEC) to said bit reduced HD content.

16. The method of claim 1, wherein step (d) comprises applying unequal error protection (UEP) to said bit reduced HD content.

17. The method of claim 5, wherein step (i) comprises calculating values for unreliable received content based on values of reliably received neighboring content.

18. The method of claim 1, wherein said HD content comprises audio and/or video.

19. The method of claim 2, wherein portions of step (c) are performed prior to step (h).

20. The method of claim 19, wherein said portions comprise pixel bitwidth reduction.

21. The method of claim 1, wherein step (d) comprises interleaving samples in said bit reduced HD content, and wherein step (f) comprises de-interleaving said samples.

22. The method of claim 5, wherein step (i) comprises receiving an error indicator, said error indicator used to determine unreliable samples in said decrypted HD content.

23. The method of claim 12, wherein said downscaling comprises converting said HD content into an HD content format that requires a lower number of bits to represent said HD content.

24. The method of claim 12, wherein said pixel bitwidth reduction comprises reducing a number of bits required for pixel representation in video content of said HD content.

25. The method of claim 24, wherein said reducing comprises reducing numbers of bits allocated for selected color components in said pixel representation.

26. The method of claim 12, wherein said component down-sampling comprises down-sampling selected color components in video content of said HD content.

27. The method of claim 12, wherein said color space conversion comprises converting video content of said HD content from a first color space representation to a second color space representation.

28. The method of claim 12, wherein said converting comprises converting video content of said HD content from a RGB color space to a YCrCb color space, or vice versa.

29. A method for enabling secure and efficient wireless transmission of high definition (HD) content, comprising:
reducing a number of bits required to represent HD content;
applying unequal error protection (UEP) to said bit reduced HD content;
wherein said UEP biases error protection overhead in favor of selected portions of said HD content.

30. The method of claim 29, wherein said bit reduced HD content is HDCP encrypted prior to applying UEP.

31. The method of claim 29, further comprising:
transmitting said bit reduced HD content such that said selected portions are carried by selected radio frequency (RF) sub-carriers of available RF band.

32. The method of claim 29, further comprising:
increasing a probability that bit errors do not occur on bits of said selected portions of said HD content.

33. The method of claim 29, further comprising:
transmitting said HD content such that said selected portions are carried by selected bit positions within the available FEC codeword.

34. The method of claim 29, further comprising:
transmitting said HD content such that said selected portions are carried using MIMO techniques.

35. A method for enabling secure and efficient wireless transmission of high definition (HD) content, comprising:
receiving encrypted HD content;
reducing a number of bits required to represent said HD content;
transmitting said bit reduced encrypted HD content over a wireless link,
wherein said reducing step operates without decrypting said encrypted HD content.

36. The method of claim 35, wherein said HD content is HDCP encrypted.

37. The method of claim 35, wherein said reducing comprises performing pixel bitwidth reduction.

38. A method for enabling secure and efficient wireless transmission of high definition (HD) content, comprising:
receiving encrypted HD content;
formatting said encrypted HD content for wireless transmission;
transmitting said formatted HD content over a wireless link;
receiving and de-formatting said transmitted HD content;
decrypting said HD content; and
performing HD signal restoration on said HD content.

39. The method of claim 38, wherein said HD content is encrypted using HDCP.

40. The method of claim 38, wherein said performing HD signal restoration step comprises calculating values for unreliable received content based on values of reliably received neighboring content.

41. A method for enabling secure and efficient wireless transmission of high definition (HD) content, comprising:
receiving HD content;
reducing a number of bits required to represent said HD content;
applying unequal error protection (UEP) to said HD content;
formatting said HD content for wireless transmission;
transmitting said formatted HD content over a wireless link; and
receiving and de-formatting said transmitted HD content.
